(19) United States
(12) Patent Application Publication
(10) Pub. No.: US 2012/0330456 A1
(43) Pub. Date: Dec. 27, 2012

(54) NUMERICAL CONTROL DEVICE AND CONTROL METHOD OF NUMERICAL CONTROL DEVICE

(75) Inventors: Takeshi Tsuda, Chiyoda-ku (JP); Tomonori Sato, Chiyoda-ku (JP); Shunro Ono, Chiyoda-ku (JP); Daisuke Fujino, Chiyoda-ku (JP)

(73) Assignee: MITSUBISHI ELECTRIC CORPORATION, Chiyoda-ku, Tokyo (JP)

(21) Appl. No.: 13/583,509

(22) PCT Filed: Mar. 8, 2010
(86) PCT No.: PCT/JP2010/001607

§ 371 Date: Sep. 7, 2012

(51) Int. Cl. G05B 19/19

(52) U.S. Cl. 700/186

(57) ABSTRACT

A numerical control device includes a retraction-direction decision unit that decides a retracting direction of the tool when determining that the tool deviates from the movable range, and a tool-locus correction unit that corrects a locus of the tool based on this retracting direction so that a distance between the tool and a rotation center of a table while retracting is equal to or larger than a distance between the tool and the rotation center of the table at a time of either the start of rotation of the table or the end of the rotation of the table. According to the present invention, it is possible to avoid a stroke-over while avoiding interference between the tool and a workpiece when a table rotation command that possibly causes a stroke-over on the linear axis is issued while executing a control on a coordinate system other than a machine coordinate system.

### FIELD

The present invention relates to a numerical control device that controls a machine tool having a plurality of linear axes for moving a tool and a table rotating axis for rotating a table based on a machining program thereby machining a workpiece fixed onto the table with the tool, and a control method of the numerical control device.

### BACKGROUND

As a machine tool that has a plurality of linear axes for moving a tool and a table rotation axis for rotating a table, there are conventionally known, for example, five-axis processing machines shown in FIGS. 8 and 9. FIG. 8 is an external view of a five-axis processing machine that has three linear axes, one table rotation axis, and one tool rotation axis. The five-axis processing machine shown in FIG. 8 moves a tool 102 by three linear axes of an X-axis, a Y-axis and a Z-axis which are orthogonal to each other, rotates a table 101 by a C-axis that rotates around the Z-axis, and rotates the tool 102 by a B-axis that rotates around the Y-axis, thereby machining a workpiece 100 fixed onto the table 101. On the other hand, FIG. 9 is an external view of a fix-axis processing machine that has three linear axes and two table rotation axes. The five-axis processing machine shown in FIG. 9 moves the tool 102 by three linear axes of the X-axis, Y-axis and the Z-axis which are orthogonal to each other, and rotates the table 101 by the C-axis that rotates around the Z-axis and an A-axis that rotates around the X-axis, thereby machining the workpiece 100 fixed onto the table 101.

Such a machine tool often moves a tool by performing interpolation on a coordinate system different from a machine coordinate system that is preset to the machine tool to move the tool according to a locus and a velocity commanded by a machining program with respect to a workpiece that is rotated in conjunction with the rotation of a table. For example, in a tool-tip-point control described in Patent Literature 1, a control is executed so that the locus and velocity on a workpiece as commanded by a machining program match those of a blade edge position of a tool (hereinafter, “tool tip point”) on the workpiece, respectively, and interpolation is performed on a table coordinate system that is fixed to a table and that rotates in conjunction with the rotation of the table, thereby moving the tool.

In the tool-tip-point control described in Patent Literature 1, when a rotation command to a table rotation axis (hereinafter, “table rotation command”) is issued, the tool tip point moves in conjunction with the rotation of the table so as to keep relative positions of the tool tip point and the table. Accordingly, it is difficult for a machining program creator to create the machining program while confirming that a position commanded to each drive axis falls within a preset movable range in a machining-program creation phase. As a result, a state where the position commanded to each drive axis deviates from the movable range (hereinafter, “stroke-over”) may occur during execution of the machining program.

A conventional numerical control device is described with reference to FIG. 10. FIG. 10 are explanatory diagrams of the conventional numerical control device. A heavy line arrow shown in FIG. 10 indicates a locus of the tool tip point when the tool tip point moves from a block start point A to a block end point B in conjunction with the rotation of the table in response to a C-axis rotation command while executing a tool-tip-point control. A broken line shown in FIG. 10 indicates a movable range 260 of each drive axis. FIG. 10(a) depicts an example in which a stroke-over occurs on the Y-axis viewed from a Z-axis positive direction. The stroke-over occurs when a position commanded to the Y-axis deviates from a movable lower limit Y_{L} on a locus from a point C to a point D located on a locus on which the tool tip point moves from a point A to a point B.

If each drive axis is forced to operate despite the occurrence of the stroke-over, the operation deviates from the movable range, resulting in breakage of the drive axis. Therefore, to avoid the stroke-over, the conventional numerical control device transmits a command of the locus of the tool tip point while dividing the command into a plurality of moving commands as shown in FIG. 10(b). FIG. 10(b) depicts a locus obtained by correcting the locus of the tool tip point according to the machining program shown in FIG. 10(a). The conventional numerical control device turns on the tool-tip-point control and transmits a command of “GO C60” on a locus from the point A to the point C, turns off the tool-tip-point control and transmits a command of “GO X-10” on the locus from the point C to the point D on which the stroke-over occurs, and turns on the tool-tip-point control and transmits a command of “GO C180” on a locus from the point D to the point B, thereby continuing operating.

### CITATION LITERATURE

### Patent Literature

Patent Literature 1: Japanese Patent No. 3643098

### SUMMARY

### Technical Problem

However, the conventional numerical control device has the following problems. While the tool tip point moves on the locus from the point C to the point D shown in FIG. 10(b), the distance between the tool tip point and a table rotation center O decreases, which may cause interference between the tool and the workpiece. Furthermore, it takes a long time to modify the machining program in order that the numerical control device can continue operating as shown in FIG. 10(b).

Furthermore, as a method of avoiding the interference between the tool and the workpiece when the distance between the tool tip point and the table rotation center O shown in FIG. 10(b) decreases, a method of modifying the machining program so as to transmit a command to rotate the A-axis that is the table rotation axis orthogonal to the C-axis is possibly proposed. However, in this case, it takes a longer time to modify the machining program.

Furthermore, a method of modifying the machining program so as to temporarily make the tool-tip-point control invalid at a time of executing a table rotation command and to make the tool-tip-point control valid after executing the table rotation command is possibly proposed in the conventional numerical control device. However, in this case, it takes a longer time to modify the machining program.

### Solution to Problem

There is provided a numerical control device that controls a machine tool having a plurality of linear axes for moving a tool and a table rotation axis for rotating a table based on a machining program, the numerical control device comprising: a storage unit that stores a movable range that is set as a range on each of the linear axes where the tool is allowed to move; a stroke-over determination unit that analyzes a table rotation command on a coordinate system other than a machine coordinate system, and that determines whether the tool deviates from the movable range on one of the linear axes when the table rotation command is executed; a retraction-direction decision unit that decides that a direction different from a direction of the linear axis on which the tool deviates from the movable range is a retracting direction of the tool, when the stroke-over determination unit determines that the tool deviates from the movable range; a tool-locus correction unit that corrects a locus of the tool based on the retracting direction so that a distance between the tool and a rotation center of the table while retracting the tool is equal to or larger than a distance between the tool and the rotation center of the table at a time of either start of rotation of the table or end of the rotation of the table; and an output unit that outputs a position command to a servo amplifier based on the locus of the tool corrected by the tool-locus correction unit.

There is provided a control method of a numerical control device that controls a machine tool having a plurality of linear axes for moving a tool and a table rotation axis for rotating a table based on a machining program, the method comprising: a storing step of storing a movable range that is set as a range on each of the linear axes where the tool is allowed to move; a stroke-over determining step of analyzing a table rotation command on a coordinate system other than a machine coordinate system, and determining whether the tool deviates from the movable range on one of the linear axes when the table rotation command is executed; a retraction-direction deciding step of deciding that a direction different from a direction of the linear axis on which the tool deviates from the movable range is a retracting direction of the tool, when it is determined at the stroke-over determining step that the tool deviates from the movable range; a tool-locus correcting step of correcting a locus of the tool based on the retracting direction so that a distance between the tool and a rotation center of the table while retracting the tool is equal to or larger than a distance between the tool and the rotation center of the table at a time of either start of rotation of the table or end of the rotation of the table; and an outputting step of outputting a position command to a servo amplifier based on the locus of the tool corrected at the tool-locus correcting step.

### Advantageous Effects of Invention

According to the present invention, it is possible to avoid a stroke-over while avoiding the interference between the tool and the workpiece when a table rotation command as a result of which the stroke-over possibly occurs on one linear axis is issued while executing a control on a coordinate system different from a machine coordinate system.

### BRIEF DESCRIPTION OF DRAWINGS

FIG. 1 is a block diagram of a configuration of an numerical control device according to a first embodiment.

FIG. 2 is a functional block diagram of functions of the numerical control device according to the first embodiment.

FIG. 3 is a flowchart of processes performed by the numerical control device according to the first embodiment.

FIG. 4 is a flowchart of processes performed by a position-correction-amount calculation unit according to the first embodiment.

FIG. 5 are explanatory diagrams of an example in which a stroke-over occurs on a Y-axis.

FIG. 6 depict a locus of a tool tip point after correction in the example shown in FIGS. 5.

FIG. 7 is an explanatory diagram of an example in which a stroke-over occurs on the Y-axis when a combination of a moving command to an X-axis and a rotation command to a C-axis is issued.

FIG. 8 is an external view of a five-axis processing machine that has three linear axes, one table rotation axis, and one tool rotation axis.

FIG. 9 is an external view of the fix-axis processing machine that has three linear axes and two table rotation axes.

FIG. 10 are explanatory diagrams of a conventional Numerical control device.

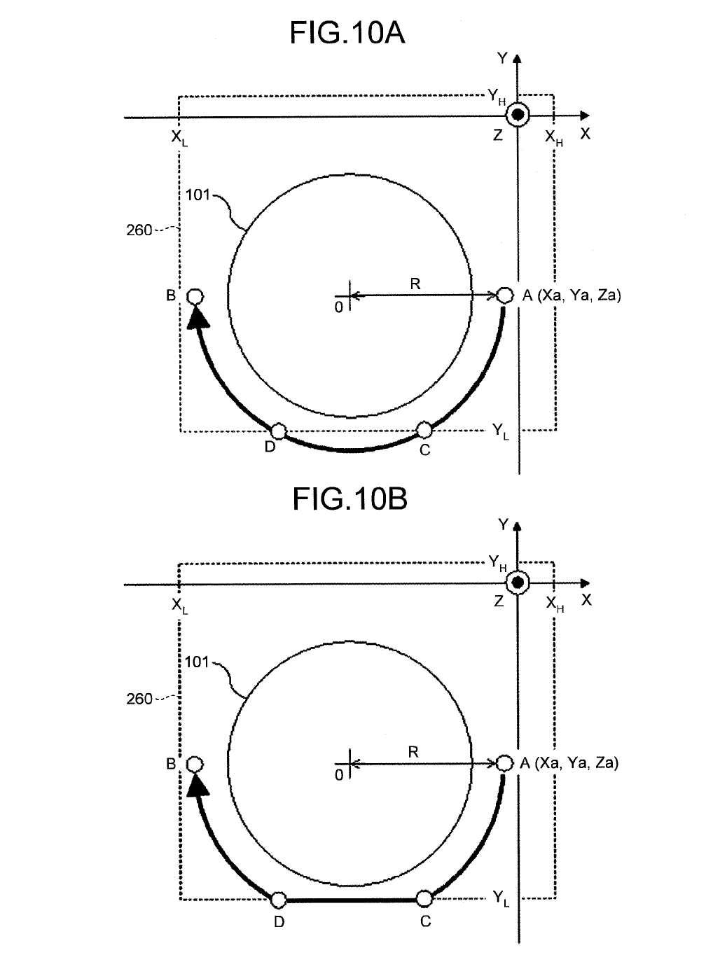

### REFERENCE SIGNS LIST

1 machining program

4 parameter

40 numerical control device

50 servo amplifier

70 motor

21 program analysis unit

22 interpolation processing unit

23 moving-amount output unit

24 movability determination unit

25 position-correction-amount calculation unit

100 workpiece

101 rotary table

102 tool

106 sphere equidistant from table rotation center

210 movement data

220 interpolation point position

230 position command

240 stroke-over occurrence signal

250 position correction amount

260 movable range

261 retracting direction table

262 position of table rotation center

### DESCRIPTION OF EMBODIMENTS

### First Embodiment

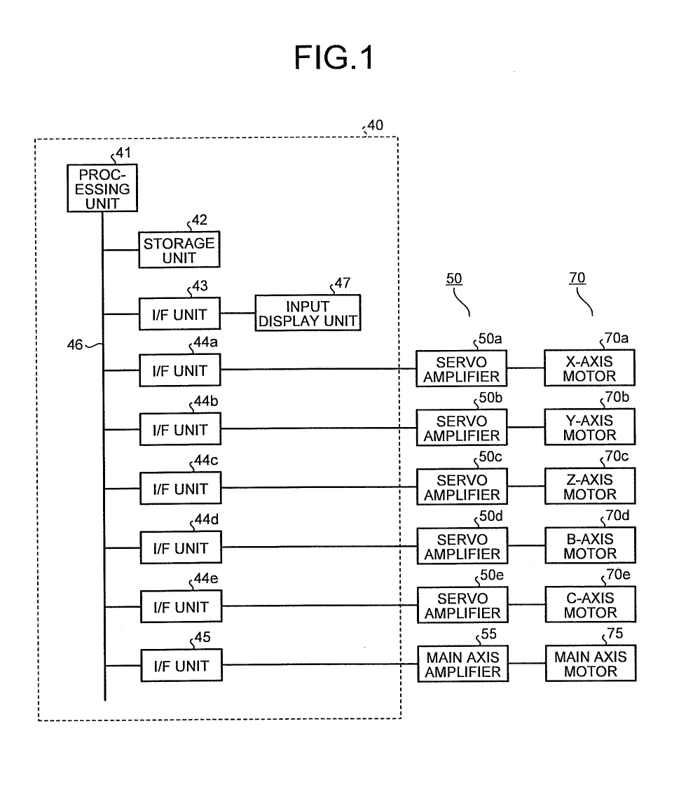

A first embodiment is explained with reference to FIG. 1 to FIG. 7.

FIG. 1 is a block diagram of a configuration of a numerical control device according to the first embodiment. An numerical control device 40 includes a processing unit 41 such as a central processing unit (CPU), and a storage unit 42 such as a read-only memory (ROM) or a random-access memory (RAM). The processing unit 41 is connected to the storage unit 42 by a bus 46. The storage unit 42 stores therein various data such as a system program, a machining program, and parameters 4 to be described later. The processing unit 41 executes the machining program according to the system program stored in the storage unit 42.

The numerical control device 40 also includes I/F units 43, 44a to 44e, and 45 connected to the bus 46, and an input display unit 47 connected to the I/F unit 43. The input display unit 47 includes a keyboard (not shown) to which a user inputs the machining program and the parameters 4 to be described later, and a display device (not shown) that shows the input machining program, parameters, and the like. Servo amplifiers 50a to 50e are connected to the I/F units 44a to 44e, respectively. An X-axis motor 70a, a Y-axis motor 70b, a Z-axis motor 70c, a B-axis motor 70d, and a C-axis motor 70e that are control targets of the servo amplifiers 50a to 50e are connected to the servo amplifiers 50a to 50e, respectively. A main axis amplifier 55 is connected to the I/F unit 45, and a main axis motor 75 that is a control target of the main axis amplifier 55 is connected to the main axis amplifier 55.

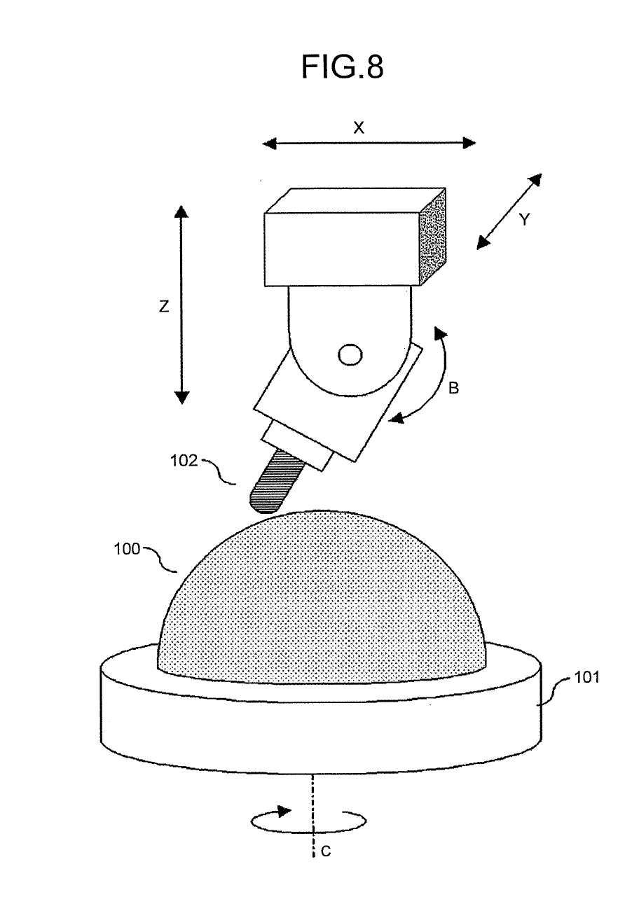

The X-axis motor 70a, the Y-axis motor 70b, the Z-axis motor 70c, the B-axis motor 70d, the C-axis motor 70e, and the main axis motor 75 drive the X-axis, the Y-axis, the Z-axis, the B-axis, the C-axis, and a main axis of a machine tool shown in FIG. 8, respectively.

In the present embodiment, the servo amplifiers 50a to 50e are collectively referred to as “servo amplifier 50”, and the X-axis motor 70a, the Y-axis motor 70b, the Z-axis motor 70c, the B-axis motor 70d, and the C-axis motor 70e are collectively referred to as “motor 70”.

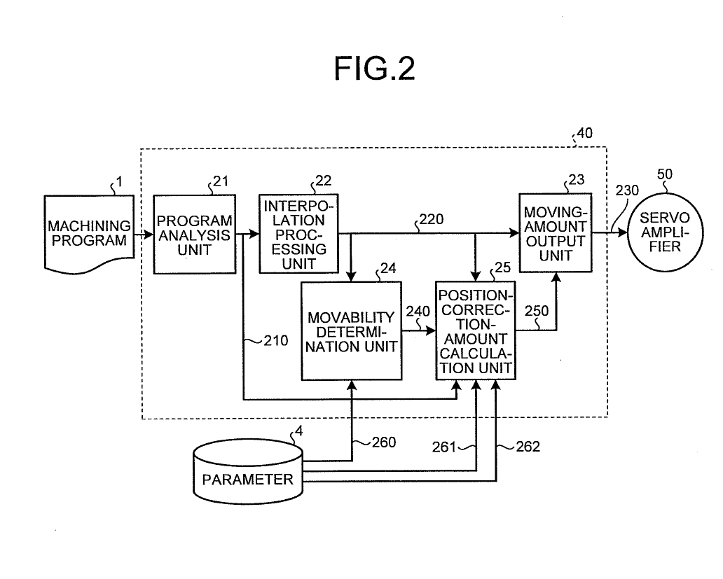

FIG. 2 is a functional block diagram of functions of the numerical control device according to the first embodiment. A machining program 1 is an NC program that is described using JIS-standard-compliant command codes referred to as “G codes”, and is input to the numerical control device 40 by the input display unit 47 shown in FIG. 1. Examples of the command codes include a positioning command (G00), a cutting command (G01), and a tool-tip-point control command (G43.4 or G43.5).

The parameters 4 are input to the numerical control device 40 by the input display unit 47 shown in FIG. 1, and stored in the storage unit 42. Types of the parameters 4 include the movable range 260 to be described later, a retracting direction table 261 to be described later, a position 262 of a rotation center O of a table, and the like. The position 262 of the table rotation center O is set as coordinates on a machine coordinate system. First, the position 262 of the table rotation center O on the X-axis and the Y-axis orthogonal to the C-axis, that is, an X coordinate and a Y coordinate of the table rotation center O are set based on a mechanical configuration of a machine tool. On the other hand, the position 262 of the table rotation center O which is on the Z-axis and which is in parallel to the C-axis, that is, a Z coordinate of the table rotation center O can be arbitrarily set. To facilitate creating the program, it is desirable to set the Z coordinate to a position closer to the table. In the present embodiment, the Z coordinate of the table rotation center O set between upper and lower surfaces of the table.

The numerical control device 40 outputs a position command 230 to the servo amplifier 50 by analyzing the machining program 1 and performing an interpolation process and an acceleration and deceleration process. The numerical control device 40 includes a program analysis unit 21, an interpolation processing unit 22, a movability determination unit 24, a position-correction-amount calculation unit 25, and a moving-amount output unit 23 to be described later. Operations performed by these units are realized by executing the system program stored in the storage unit 42 by the processing unit 41 shown in FIG. 1.

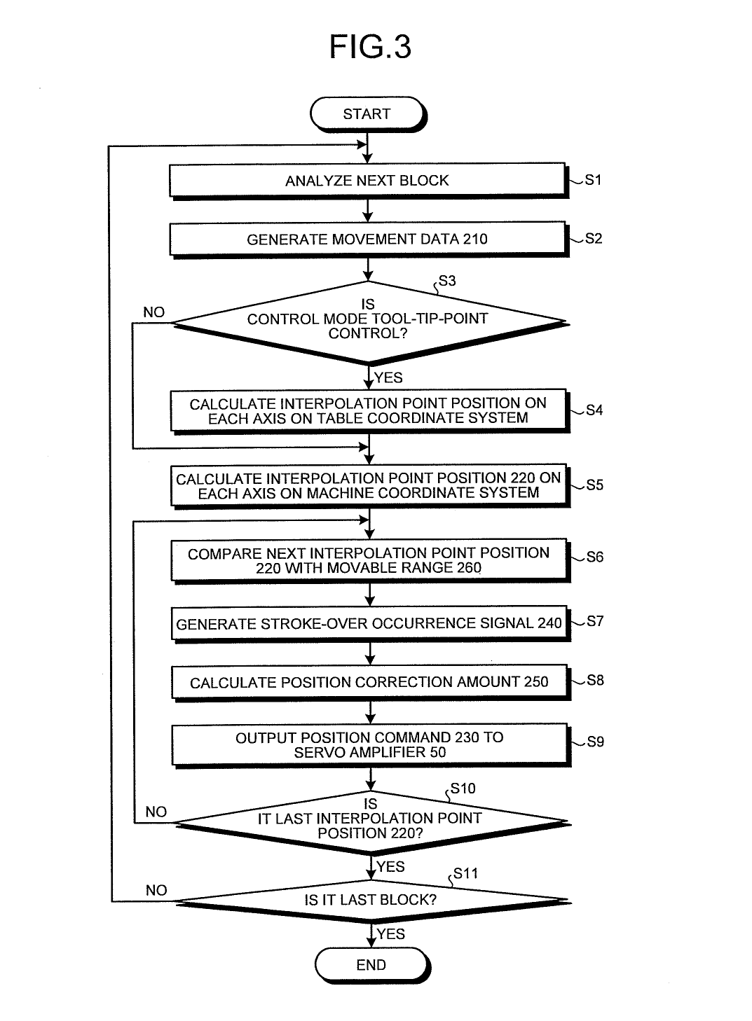

With reference to FIG. 3, processes performed by the numerical control device 40 are described next. FIG. 3 is a flowchart of processes performed by the numerical control device according to the first embodiment.

First, the program analysis unit 21 analyzes a next block in the machining program 1 (Step S1). The “next block” means a first block among blocks in the machining program 1 when no blocks has been already analyzed by the program analysis unit 21, and means a next block to a block analyzed just before the next block when at least one block has been already analyzed. A command code and a command to each axis are described in each of the blocks.

The program analysis unit 21 then generates movement data 210 based on the block analyzed at S1 (Step S2). The movement data 210 includes such information as a moving mode, a coordinate system, a block start position on the machine coordinate system, a block end point on the machine coordinate system, a moving distance, an interpolation mode, a control mode, and a moving velocity. Types of the moving mode include a cut and feed mode for moving while cutting, a positioning mode for moving without cutting, and the like. Types of the coordinate system include the machine coordinate system preset to the machine tool and a table coordinate system that is fixed to the table and that rotates in conjunction with the rotation of the table. Types of the interpolation mode include a linear interpolation mode, a circular interpolation mode, a non-interpolation mode, and the like. Types of the control mode include a control mode for executing a control on the machine coordinate system and a tool-tip-point control mode for executing a tool-tip-point control on the table coordinate system. In the control on the machine coordinate system, the table and the tool operate independently with each other. In the tool-tip-point control, the table and the tool operate while keeping a constant relative position relation therebetween.

The interpolation processing unit 22 then determines whether the control mode of a current block is the tool-tip-point control mode by referring to the control mode included in the movement data 210 generated by the program analysis unit 21 at S2 (Step S3). When the interpolation processing unit 22 determines that the control mode is the tool-tip-point control mode at S3, this indicates that the coordinate system is the table coordinate system and therefore the interpolation processing unit 22 then calculates an interpolation point position of each of the five axes on the table coordinate system (Step S4). Thereafter, the interpolation processing unit 22 calculates an interpolation point position 220 of each of the five axes on the machine coordinate system based on the interpolation point position of each axis calculated at S4 (Step S5). The calculation method at S4 and S5 is not described here because the method can be achieved by the well-known technique disclosed in Patent Literature 1 or the like. On the other hand, when the interpolation processing unit 22 determines that the control mode of the current block is not the tool-tip-point control mode at S3, this indicates that the coordinate system is the machine coordinate system and therefore the interpolation processing unit 22 then proceeds to S5. At S5, the interpolation processing unit 22 calculates the interpolation point position 220 of each of the five axes on the machine coordinate system.

In the following explanations, it is assumed that the current block is a block where a table rotation command that is represented by “G00 C180.” and that indicates rotation of the C-axis by 180 degrees is commanded while executing the tool-tip-point control on the table coordinate system. The moving mode of this C-axis rotation command is a mode for positioning without cutting.

When the interpolation processing unit 22 calculates the interpolation position point 220 on the machine coordinate system at S5, the movability determination unit 24 then compares a next interpolation point position 220 with the movable range 260 on each of the X-axis, the Y-axis, and the Z-axis (Step S6). The “next interpolation point position 220” means the first interpolation point position 220 when no interpolation point position 220 has already been compared with the movable range 260 by the movability determination unit 24 among the interpolation point positions 220 on the machine coordinate system calculated by the interpolation processing unit 22 at S5, and means the next interpolation point position 220 to one interpolation point position 220 compared just before when at least one interpolation point position 220 has already been compared with the movable range 260. The movable range 260 is defined by movable upper-limit coordinates and movable lower-limit coordinates on the respective X-axis, Y-axis, and Z-axis on the machine coordinate system, and is a range on the linear axes on which interpolation is allowed (moving of a tip end point is allowed). In the present embodiment, the movable upper-limit coordinates and the movable lower-limit coordinates are assumed to be set by the following Equations (1) and (2), respectively.

(Movable upper-limit X-axis coordinate, movable upper-limit Y-axis coordinate, movable upper-limit Z-axis coordinate)=(X_{H}, Y_{H}, Z_{H}) (1)

(Movable lower-limit X-axis coordinate, movable lower-limit Y-axis coordinate, movable lower-limit Z-axis coordinate)=(X_{L}, Y_{L}, Z_{L}) (2)

Next, the movability determination unit 24 generates a stroke-over occurrence signal 240 based on a result of the comparison at S6 (Step S7). The stroke-over occurrence signal 240 is a signal that can determine a valid or invalid state of each linear axis, in which the axis on which the interpolation point position 220 is within the movable range 260 is set as the axis in the invalid state and the axis on which the interpolation point position 220 is out of the movable range 260 is set as the axis in the valid state. At this interpolation point position 220, the stroke-over occurrence signal 240 that indicates the axis is in the invalid state means that no stroke-over occurs on the axis, and that indicates the axis in the valid state means that a stroke-over occurs on the axis.

The position-correction-amount calculation unit 25 calculates a position correction amount 250 corresponding to each of the X-axis, the Y-axis, and the Z-axis based on the interpolation point position 220 and the stroke-over occurrence signal 240 (Step S8). The position correction amount 250 is a correction amount used when correcting the interpolation point position 220 at which the movability determination unit 24 determines that a stroke-over occurs at S7, thereby avoiding the stroke-over. A process performed by the position-correction-amount calculation unit 25 at S8 is described later in detail.

The moving-amount output unit 23 performs the acceleration and deceleration process by adding up the interpolation point position 220 and the position correction amount 250, thereby calculates the position command 230, and outputs the position command 230 to the servo amplifier 50 (Step S9). Thereafter, the servo amplifier 50 controls the motor 70 to be driven by a servo control based on the position command 230.

The movability determination unit 24 determines whether the interpolation point position 220 is the last interpolation point position 220 in the current block (Step S10), and returns to S6 when the interpolation point position 220 is not the last interpolation point position 220. On the other hand, when the movability determination unit 24 determines that the interpolation point position 220 is the last interpolation point position 220 at S10, the program analysis unit 21 then determines whether the current block is the last block in the machining program 1 (Step S11), and returns to S1 when the current block is not the last block. Meanwhile, when the program analysis unit 21 determines that the current block is the last block, the process ends.

In this way, according to the present embodiment, each interpolation point position 220 calculated for each of all the blocks in the machining program 1 is compared with the movable range 260, thereby determining whether correction is necessary to make. For the interpolation point position 220 necessary to correct as a result of occurrence of a stroke-over, the position correction amount 250 for every axis is calculated and the stroke-over can be avoided.

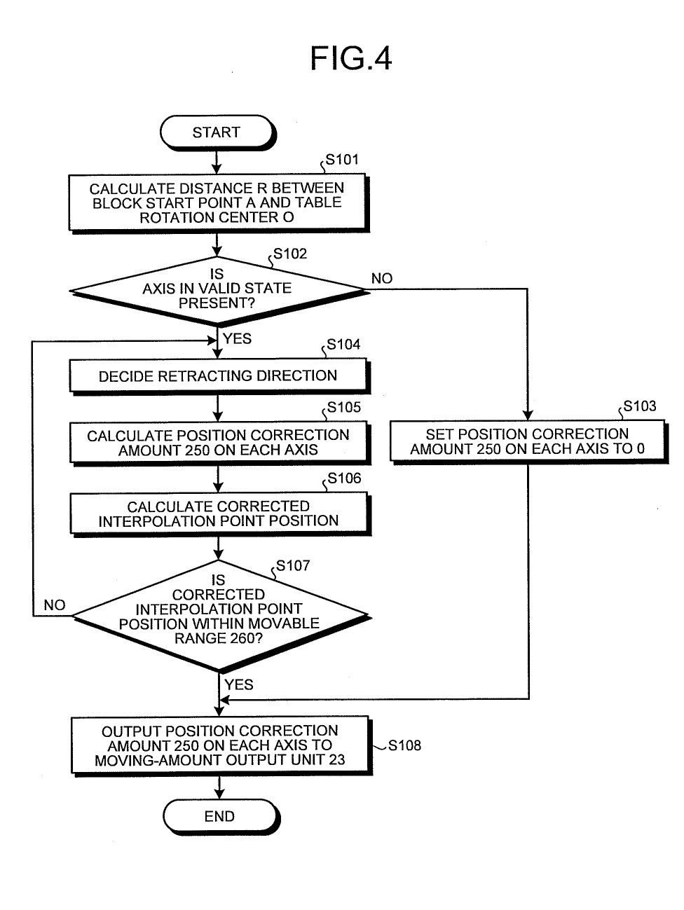

With reference to FIGS. 4 to 6, process performed by the position-correction-amount calculation unit 25 for calculating the position correction amount 250 are described next. The processes performed by the position-correction-amount calculation unit 25 described hereafter correspond to S8 in FIG. 3. FIG. 4 is a flowchart of processes performed by the position-correction-amount calculation unit 25 according to the first embodiment.

First, the position-correction-amount calculation unit 25 calculates, based on a distance R between a position (Xa, Ya, Za) of the block start point A on the machine coordinate system included in the movement data 210 generated by the program analysis unit 21 at S2 in FIG. 3 and the position 262 (Xo, Yo, Zo) of the table rotation center O input as the parameters 4, a distance R between the position (Xa, Ya, Za) and the position 262 (Xo, Yo, Zo) as expressed by the following Equation (3) (Step S101).

R=\sqrt{(Xₐ−X₀)²+(Yₐ−Y₀)²+(Zₐ−Z₀)²} (3)

The position-correction-amount calculation unit 25 determines whether there is an axis in a valid state among the X-axis, the Y-axis, and the Z-axis based on the stroke-over occurrence signal 240 output by the movability determination unit 24 at S7 in FIG. 3 (Step S102). When determining that there is no axis in the valid state, the position-correction-amount calculation unit 25 sets the position correction amount 250 corresponding to each axis to zero (0) (Step S103), and then proceeds to S108.

On the other hand, when determining that there is an axis in the valid state at S102, the position-correction-amount calculation unit 25 decides a retracting direction based on the retracting direction table 261 stored in the storage unit 42 in FIG. 1 (Step S104). This retracting direction is a correcting direction in which the interpolation point position 220 is corrected so as to avoid a stroke-over at the interpolation point position 220 at which the stroke-over occurs. Note that only one retracting direction can be stored in the retracting direction table 261, or a plurality of retracting directions can be stored therein to correspond to priorities, respectively, as shown in the following Table 1.

TABLE 1

| Priority | Retracting direction |
|---|---|
| First | Z-axis positive direction |
| Second | Y-axis positive direction |
| Third | X-axis positive direction |
| Fourth | Z-axis negative direction |

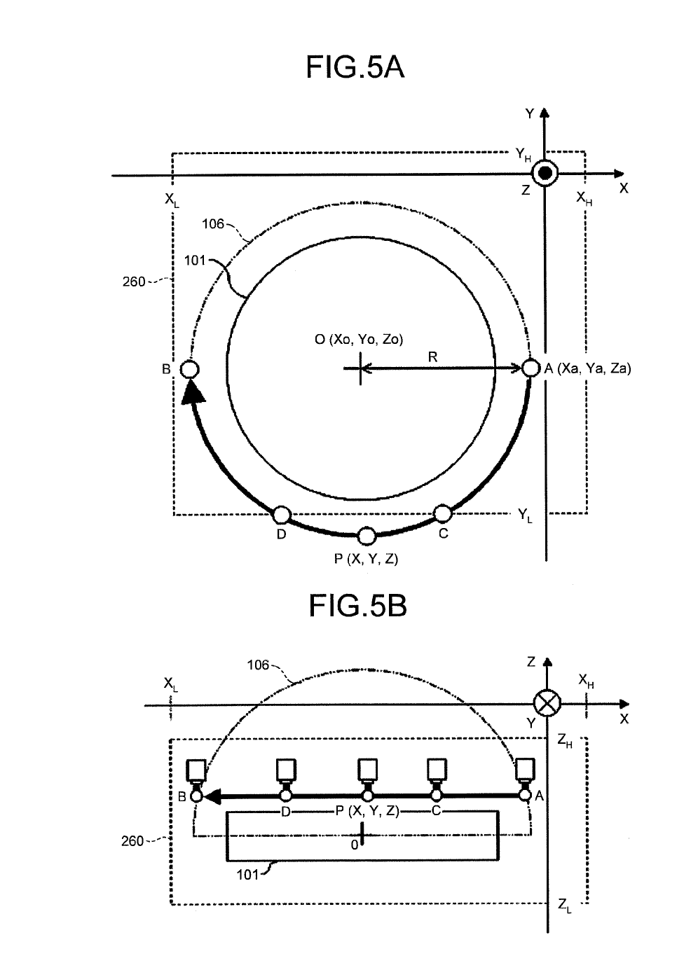

The process is specifically described while taking a case shown in FIG. 5 as an example. FIGS. 5(a) and 5(b) are an example in which a stroke-over occurs on the Y-axis viewed from a Z-axis positive direction and a Y-axis negative direction, respectively. A heavy line arrow shown in FIG. 5 indicates a locus of a tool tip point when the tool tip point moves from the block start point A to the block end point B in conjunction with the rotation of the table in response to a C-axis rotation command represented by “G00 C180.” while executing the tool-tip-point control. A broken line shown in FIG. 5 indicates the movable range 260. A two-dot chain line shown in FIG. 5 indicates an equidistant sphere 106 with the table rotation center O defined as a center and a radius defined as the R expressed by the Equation (3). A stroke-over occurs on a locus from the point C to the point D on which the tool deviates from a movable lower-limit Y-axis coordinate Y_{L} that is present on the orbit from the point A to the point B.

It is assumed that the current interpolation point position 220 is a point P (X, Y, Z) present between the point C and the point D, and that the retracting direction table 261 is the Table 1. At this time, the stroke-over occurrence signal 240 at the point P indicates that the Y-axis is in the valid state and that the X-axis and the Z-axis are in the invalid state. Therefore, at S104, the position-correction-amount calculation unit 25 excludes Y-axis positive and negative directions in the valid state among the retracting directions stored in the retracting direction table 261, and selects the Z-axis positive direction having the highest priority among the remaining retracting directions.

After S104, the position-correction-amount calculation unit 25 calculates the position correction amount 250 corresponding to each of the X-axis, the Y-axis, and the Z-axis based on the retracting direction decided at S103 (Step S105). First, the position-correction-amount calculation unit 25 fixes a Y coordinate of the tool tip point on the locus from the point C to the point D on which a stroke-over occurs to the movable lower-limit coordinate Y_{L} of the movable range 260. Furthermore, because the retracting direction decided at S104 is the Z-axis positive direction, the position correction amount 250 corresponding to each axis is set as expressed by the following Equation (4).

(X-axis position correction amount, Y-axis position correction amount, Z-axis position correction amount)=(0, 0, C_{z}) (4)

The Z-axis position correction amount CZ in the Z-axis positive direction shown in the Equation (4) is calculated as expressed by the following Equation (5) so as to make the distance between the point P that is the interpolation point position 220 and the table rotation center O equal to the constant value R.

R=\sqrt{(X−X₀)²+(Y−Y₀)²+(Z+C_{z}−Z₀)²} (5)

By using this Equation (5) and Y=Y_{L}, the following Equation (6) is obtained.

C_{z}=\sqrt{R²−(X−X₀)²−(Y_{L}−Y₀)²}−(Z−Z₀) (6)

By using this Equation (6) and the Equation (1), the Z-axis position correction amount C_{z} can be calculated.

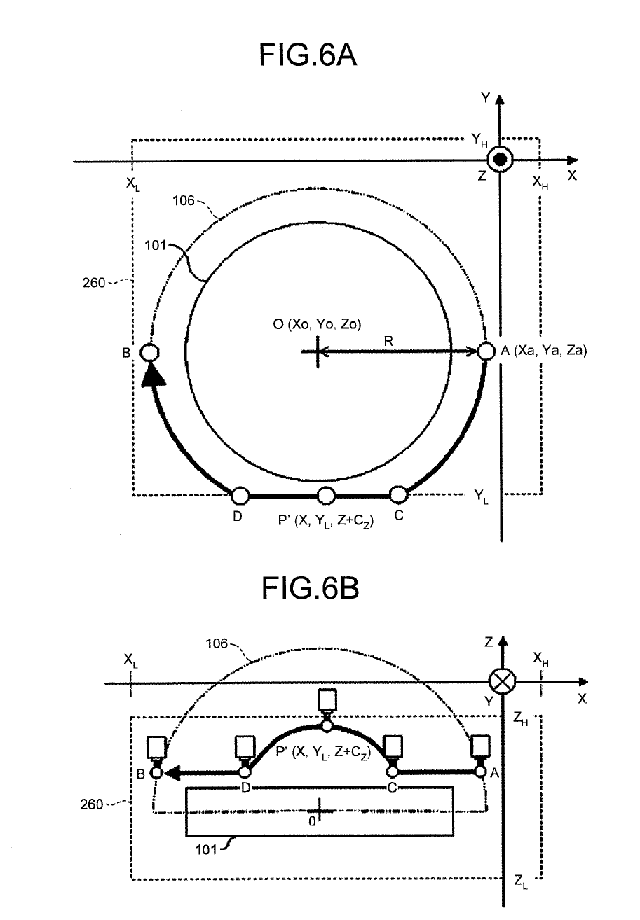

After calculating the position correction amount 250 at S105, the position-correction-amount calculation unit 25 adds up the interpolation point position 220 and the position correction amount 250, sets the Y-axis coordinate to the movable lower-limit Y_{L} on the Y-axis and calculates a corrected interpolation point position (Step S106). As shown in FIG. 6, an interpolation point position P′ obtained by correcting the interpolation point position P is (X, Y_{L}, Z+C_{z}). FIGS. 6(a) and 6(b) depict a locus of the tool tip point after each interpolation point position 220 from the point C to the point D is corrected by the above method in the example shown in FIG. 5. FIGS. 6(a) and 6(b) correspond to FIGS. 5(a) and 5(b), respectively. As shown in FIG. 6, each interpolation point position 220 from the point C to the point D is corrected so as not to deviate from the movable range 260.

Next, the position-correction-amount calculation unit 25 compares the corrected interpolation point position P′ with the movable range 260, and determines whether the corrected interpolation point position P′ falls within the movable range 260 (Step S107). When determining that the corrected interpolation point position P′ falls within the movable range 260, the position-correction-amount calculation unit 25 proceeds to S108.

On the other hand, at S107, when determining that the corrected interpolation point position P′ is out of the movable range 260, the position-correction-amount calculation unit 25 returns to S104, and at S104, the position-correction-amount calculation unit 25 determines the retracting direction different from the already decided detraction position. A process performed by the position-correction-amount calculation unit 25 after returning to S104 is described while referring to the case where the position-correction-amount calculation unit 25 determines that the corrected interpolation point position P′ deviates from the movable upper limit Z_{H} on the Z-axis as an example. First, at S104, similarly to the process described above, the position-correction-amount calculation unit 25 decides the retracting direction. In this case, the position-correction-amount calculation unit 25 excludes the Y-axis positive and negative directions for which the stroke-over occurrence signal 240 indicates the valid state among the retracting directions in the retracting direction table 260. The position-correction-amount calculation unit 25 also excludes the Z-axis positive direction already decided as the retracting direction. The position-correction-amount calculation unit 25 selects the X-axis positive direction having the highest priority among the remaining retracting directions.

At S105, the position-correction-amount calculation unit 25 sets the position correction amount 250 corresponding to each axis as expressed by the following Equation (7).

(X-axis position correction amount, Y-axis position correction amount, Z-axis position correction amount)=(Cₓ, 0, Z_{H}−Z) (7)

In the Equation (7), Cₓ is the position correction amount to the X-axis positive direction. The position-correction-amount calculation unit 25 calculates the Cₓ as expressed by the following Equation (8) similarly to the Equation (6).

Cₓ={square root over (R²−(y_{L}−Y)²−{Z+(Z_{H}−Z)−Z₀}²)}−(X−X₀) (8)

The X-axis position correction amount CX can be calculated based on the Equation (8) and the Equation (1).

At S108, the position-correction-amount calculation unit 25 outputs the position correction amount 250 calculated at S105 and corresponding to each axis to the moving-amount output unit 23 (Step S108), and then finishes the process.

According to the present embodiment, when the table rotation command as a result of which a stroke-over possibly occurs on one of the linear axes is issued while executing the tool-tip-point control, the tool is retracted while the distance between the tool tip point and the table rotation axis center is kept constant from a time of the start of the rotation of the table until a time of end of the rotation of the table, thereby making it possible to avoid the stroke-over. It is thereby possible to avoid the interference between the tool and the workpiece during retraction of the tool. Furthermore, because the interpolation point positions are automatically corrected while executing the machining program, the machining program is unnecessary to modify and the machining program can be easily created. Furthermore, because a plurality of retracting directions can be stored in the retracting direction table in advance, it is possible to avoid the stroke-over with a high probability as compared with the case of storing only one retracting direction in the retracting direction table.

In the first embodiment, the distance between the tool tip point and the table rotation center during the retraction of the tool is set to be equivalent to the distance between the tool tip point and the table rotation center at the time of the start of the rotation of the table in response to the table rotation command. However, the distance is not limited thereto. For example, the distance between the tool tip point and the table rotation center during the retraction of the tool can be set to be equal to or larger than the distance between the tool tip point and the table rotation center at the time of the start of the rotation of the table in response to the table rotation command. With this setting, it is possible to avoid the interference between the tool and the workpiece with a higher probability during the retraction of the tool.

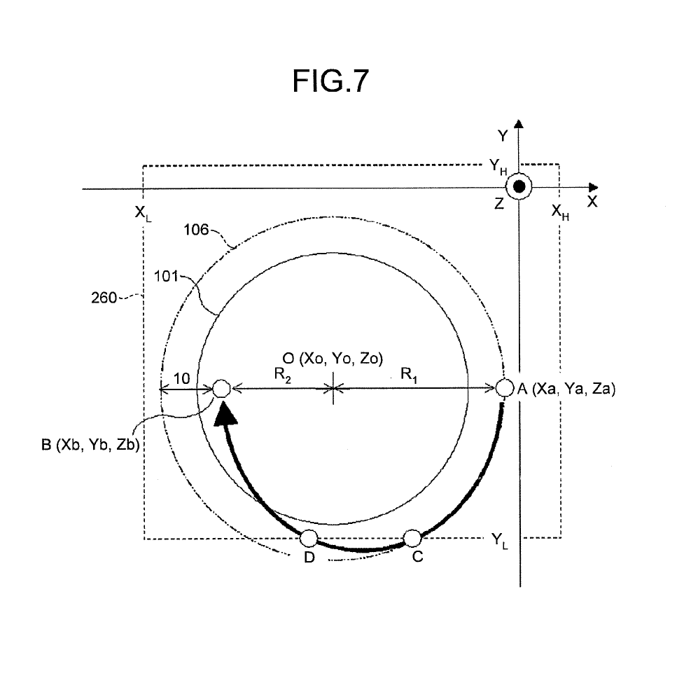

Alternatively, the distance between the tool tip point and the table rotation center during the retraction of the tool can be set equal to or larger than the distance between the tool tip point and the table rotation center at the time of either the start of the rotation of the table or the end of the rotation of the table in response to the table rotation command. With this setting, effects similar to those of the first embodiment can be achieved even when the distance between the tip end point and the table rotation center differs between the time of the start of the rotation of the table and that of the end of the rotation of the table. A case shown in FIG. 7 is described as a specific example. FIG. 7 depicts an example in which a stroke-over occurs on the Y-axis when a combination of a moving command to the X-axis and that to the Y-axis are issued as expressed by “G00 X-10. C180.”, and corresponds to FIG. 5(a). In this case, a distance R₁ between the table rotation center O and the block start point A (Xa, Ya, Za) differs from a distance R₂ between the table rotation center O and the block end point B (Xb, Yb, Zb). Therefore, by setting the distance between the tool tip point and the table rotation center O during the retraction of the table to be equal to or larger than the R₁ or the R₂, effects identical to those of the first embodiment can be achieved.

In the first embodiment, the retracting direction is decided based on the priorities made to correspond to the respective retracting directions in the retracting direction table 261. However, the decision method is not limited thereto. For example, the retracting direction can be decided based on the interpolation point position 220 at which a stroke-over occurs. With this configuration, a direction away from the table based on the interpolation point position 220 can be determined as the retracting direction. This can facilitate determining the retracting direction in which the interference between the tool and the workpiece can be avoided.

In the first embodiment, one of the directions of the linear axes of the X-axis, the Y-axis, and the Z-axis on the machine coordinate system preset to the machine tool is decided as the retracting direction. However, the decision method is not limited thereto. For example, one of directions of linear axes of an X′-axis, a Y′-axis, and a Z′-axis on the table coordinate system that is fixed to the table and that rotates in conjunction with the rotation of the table can be decided as the retracting direction. This can facilitate determining the retracting direction in which the interference between the tool and the workpiece can be avoided based on a rotation angle of the table.

The retracting direction ca be decided from among not only the linear axis directions but also rotation axis directions of the table rotation axis and the tool rotation axis. Even in this case, effects similar to those of the present embodiment can be achieved.

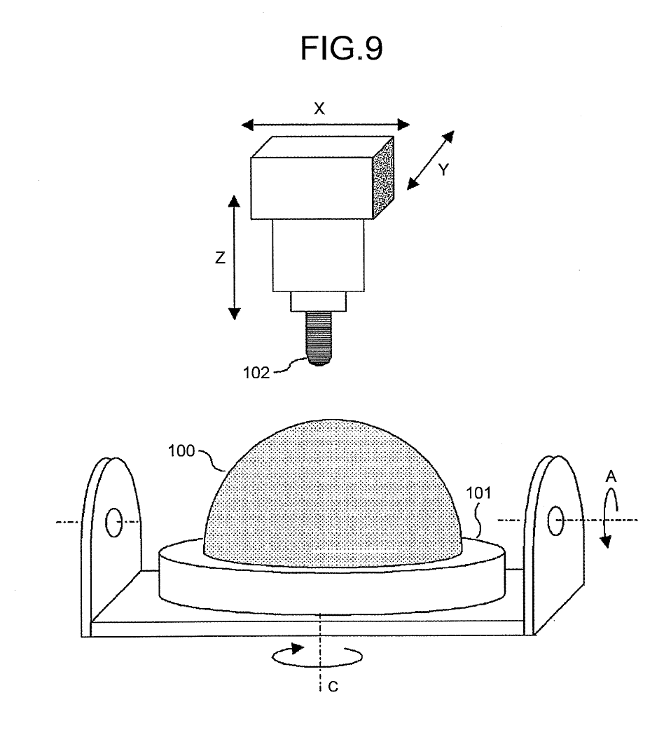

In the first embodiment, the case where the machine tool has one table rotation axis as shown in FIG. 8 has been described. Alternatively, the machine tool that has a plurality of table rotation axes can be applied to the present invention, as shown in FIG. 9. In this case, a point at which these table rotation axes intersect can be set as the table rotation center. Even in this case, effects similar to those of the present embodiment can be achieved.

When the machine tool has a plurality of table rotation axes, the retracting direction can be decided based on one of the table rotation axes that is rotating during the occurrence of the stroke-over. For example, in the case shown in FIG. 9, when the A-axis is rotating during the occurrence of the stroke-over, an X′-axis direction of the table coordinate system is decided as the retracting direction. When the C-axis is rotating during the occurrence of the stroke-over, a Z′-axis direction of the table coordinate system is decided as the retracting direction. This can facilitate determining the retracting direction in which the interference between the tool and the workpiece can be avoided based on a rotation state of the table rotation axis.

When the tool of the machine tool has a rotation axis, one of directions of linear axes on a tool coordinate system that is fixed to the tool and that rotates in conjunction with rotation of the tool rotation axis can be set as the retracting direction. This can facilitate determining the retracting direction in which the interference between the tool and the workpiece can be avoided based on a tool attitude.

The numerical control device 40 can include a retraction-velocity decreasing unit that decreases a commanded velocity at the interpolation point position 220 when the movability determination unit 24 determines that there is at least one axis deviating from the movable range 260 at S6 in FIG. 3. This makes it possible to perform a tool retraction operation at a low velocity, for an operator to easily confirm whether the machine tool operates, and to improve production efficiency.

The numerical control device 40 can include an alarm unit that issues an alarm via a display device of the input display unit 47 or the like when the position-correction-amount calculation unit 25 performs the process at S104 to S107 in FIG. 4 for all the retracting directions stored in the retracting direction table 261, and then determines that a stroke-over is unavoidable at the interpolation point positions 220. This makes it possible to notify the operator that a stroke-over is unavoidable, for the operator to promptly stop the operation, and to improve the production efficiency.

The numerical control device 40 can include a correction notification unit that notifies the operator that the position correction amount 250 corresponding to each axis and output at S108 in FIG. 4 is being output when the position correction amount 250 is not zero (0). This makes it possible to notify the operator that the interpolation point position 220 is being corrected, for the operator to easily confirm whether the machine tool operates, and to improve the production efficiency.

In the first embodiment, the movability determination unit 24 determines whether a stroke-over occurs and the position-correction-amount calculation unit 25 calculates the position correction amount 250 for every interpolation point position 220. However, determination and correction methods are not limited thereto. For example, the program analysis unit 21 can determine whether a stroke-over occurs when analyzing each block, divide the table rotation command into a command on a locus on which no stroke-over occurs and a command on a locus on which a stroke-over occurs when determining that the stroke-over occurs, and change only the command on locus on which the stroke-over occurs. That is, the methods are described while taking the case of FIG. 5 as an example. The program analysis unit 21 divides the table rotation command from the block start point A to the block end point B into three commands, that is, a table rotation command on a locus from the point A to the point C on which no stroke-over occurs, a table rotation command on a locus from the point D to the point B on which no stroke-over occurs, and a table rotation command on the locus from the point C to the point D on which a stroke-over occurs. The program analysis unit 21 then changes the table rotation command from the point C to the point D shown in FIG. 5 to the moving command from the point C to the point D shown in FIG. 6 based on the retracting direction table 261. This makes it unnecessary for the movability determination unit 24 to determine whether a stroke-over occurs and for the position-correction-amount calculation unit 25 to calculate the position correction amount 250 for every interpolation point position 220. Therefore, it is possible to reduce an operation load on the numerical control device 40.

In the first embodiment, when the table rotation command as a result of which the tool tip point deviates from the movable range is issued while executing the tool-tip-point control on the table coordinate system, the locus of the tool tip point is corrected. However, the timing of correcting the locus of the tool tip point is not limited thereto. That is, the locus of the tool tip point can be corrected when the table rotation command as a result of which the tool tip point deviates from the movable range is issued while executing whatever control on the coordinate systems other than the machine coordinate system besides the tool-tip-point control. Examples of the controls on the coordinate systems other than the machine coordinate system include a workpiece-installation error correction on a workpiece coordinate system.

In the first embodiment, the interpolation point position on each linear axis for moving the tool is defined as the position of the tool tip point on the interpolation point. However, the interpolation point position on each linear axis is not limited thereto. That is, the interpolation point position on each linear axis for moving the tool can be defined as whatever position of the tool at the interpolation point.

1. A numerical control device that controls a machine tool having a plurality of linear axes for moving a tool and a table rotation axis for rotating a table based on a machining program, the numerical control device comprising:
a storage unit that stores a movable range that is set as a range on each of the linear axes where the tool is allowed to move;
a stroke-over determination unit that analyzes a table rotation command on a coordinate system other than a machine coordinate system, and that determines whether the tool deviates from the movable range on one of the linear axes when the table rotation command is executed;
a retraction-direction decision unit that decides that a direction different from a direction of the linear axis on which the tool deviates from the movable range is a retracting direction of the tool, when the stroke-over determination unit determines that the tool deviates from the movable range;
a tool-locus correction unit that corrects a locus of the tool based on the retracting direction so that a distance between the tool and a rotation center of the table while retracting the tool is equal to or larger than a distance between the tool and the rotation center of the table at a time of either start of rotation of the table or end of the rotation of the table; and
an output unit that outputs a position command to a servo amplifier based on the locus of the tool corrected by the tool-locus correction unit.

2. The numerical control device according to claim 1, wherein
the stroke-over determination unit includes
an interpolation processing unit that calculates an interpolation point position of the table rotation command, and
a movability determination unit that determines whether the interpolation point position deviates from the movable range on any one of the linear axes,
the retraction-direction decision unit decides that the direction different from the direction of the linear axis on which the tool deviates from the movable range is the retracting direction of the tool, when the movability determination unit determines that the interpolation point position deviates from the movable range,
the tool-locus correction unit includes a position-correction-amount calculation unit that calculates a position correction amount in the retracting direction for the interpolation point position so that a distance between a position obtained after correcting the interpolation point position and the rotation center of the table is equal to or larger than the distance between the tool and the rotation center of the table at the time of either the start of the rotation of the table or the end of the rotation of the table, and
the output unit outputs the position command to the servo amplifier based on the interpolation point position and the position correction amount.

3. The numerical control device according to claim 1, wherein
the storage unit stores a retracting direction table in which a plurality of directions are set to correspond to priorities, and
the retraction-direction decision unit decides that a direction that differs from the direction of the linear axis on which the tool deviates from the movable range and that has a highest priority is the retracting direction based on the retracting direction table.

4. The numerical control device according to claim 1, wherein
the retraction-direction decision unit decides that a linear axis on a coordinate system fixed to the table or the tool is the retracting direction.

5. The numerical control device according to claim 2, wherein
the storage unit stores a retracting direction table in which a plurality of directions are set to correspond to a plurality of table rotation axes, and
the retraction-direction decision unit decides that the direction corresponding to the table rotation axis that rotates when the tool is located at the interpolation point position is the retracting direction based on the retracting direction table.

6. The numerical control device according to claim 2, wherein
the retraction-direction decision unit decides that a direction away from the rotation center of the table based on the interpolation point position is the retracting direction.

7. The numerical control device according to claim 1, further comprising a retraction-velocity decreasing unit that decreases a commanded velocity when the tool retracts on the locus of the tool corrected by the tool-locus correction unit.

8. The numerical control device according to claim 2, wherein
the tool-locus correction unit includes a retraction-direction determination unit that determines whether the position obtained after correcting the interpolation point position deviates from the movable range on any of the linear axes, based on the interpolation point and the position correction amount and
the retraction-direction decision unit newly decides that a direction different from the direction already determined as the retracting direction is the retracting direction, when the retraction-direction determination unit determines that the position obtained after correcting the interpolation point position deviates from the movable range.

9. The numerical control device according to claim 8, further comprising an alarm unit that issues an alarm, when the retraction-direction determination unit determines that the position obtained after correcting the interpolation point position deviates from the movable range.

10. The numerical control device according to claim 1, further comprising a correction notification unit that notifies an operator that the locus of the tool is corrected, when the tool-locus correction unit corrects the locus of the tool.

11. A control method of a numerical control device that controls a machine tool having a plurality of linear axes for moving a tool and a table rotation axis for rotating a table based on a machining program, the method comprising:
a storing step of storing a movable range that is set as a range on each of the linear axes where the tool is allowed to move;
a stroke-over determining step of analyzing a table rotation command on a coordinate system other than a machine coordinate system, and determining whether the tool deviates from the movable range on one of the linear axes when the table rotation command is executed;
a retraction-direction deciding step of deciding that a direction different from a direction of the linear axis on which the tool deviates from the movable range is a retracting direction of the tool, when it is determined at the stroke-over determining step that the tool deviates from the movable range;
a tool-locus correcting step of correcting a locus of the tool based on the retracting direction so that a distance between the tool and a rotation center of the table while retracting the tool is equal to or larger than a distance between the tool and the rotation center of the table at a time of either start of rotation of the table or end of the rotation of the table; and
an outputting step of outputting a position command to a servo amplifier based on the locus of the tool corrected at the tool-locus correcting step.

12. The control method of a numerical control device according to claim 11, wherein
the stroke-over determining step includes
an interpolation processing step of calculating an interpolation point position of the table rotation command, and
a movability determining step of determining whether the interpolation point position deviates from the movable range on any one of the linear axes,
at the retraction-direction deciding step, it is decided that the direction different from the direction of the linear axis on which the interpolation point position deviates from the movable range is the retracting direction of the tool, when it is determined at the movability determining step that the interpolation point position deviates from the movable range,
the tool-locus correcting step includes a position-correction-amount calculating step of calculating a position correction amount in the retracting direction for the interpolation point position so that a distance between a position obtained after correcting the interpolation point position and the rotation center of the table is equal to or larger than the distance between the tool and the rotation center of the table at the time of either the start of the rotation of the table or the end of the rotation of the table, and
at the outputting step, the position command is output to the servo amplifier based on the interpolation point position and the position correction amount.
